(19) United States
(12) Patent Application Publication
(10) Pub. No.: US 2026/0029649 A1
(43) Pub. Date: Jan. 29, 2026

(54) Extended Reality Headset Assembly with Digital Optical Loupes and Method of Assembling Same

(71) Applicant: RAYTRX, LLC, Tulsa, OK (US)

(72) Inventors: Michael H. Freeman, Tulsa, OK (US); Mitchael C. Freeman, Tulsa, OK (US); Jordan Boss, Tulsa, OK (US); Montgomery H.F. Freeman, Tulsa, OK (US); Victoria McARTOR, Tulsa, OK (US); Simon Prosser, Tulsa, OK (US); Behnam Rafiee, Tulsa, OK (US); Dillon Cornell, Tulsa, OK (US); Ian Oswald, Tulsa, OK (US); David Kessler, Tulsa, OK (US); Steven Von der porten, Tulsa, OK (US)

(21) Appl. No.: 19/284,499

(22) Filed: Jul. 29, 2025

Related U.S. Application Data
(60) Provisional application No. 63/676,791, filed on Jul. 29, 2024.
(60) Provisional application No. 63/679,015, filed on Aug. 2, 2024.

(51) Int. Cl. G02B 27/01

(52) U.S. Cl. CPC G02B 27/0172; G02B 27/0176; G02B 2027/0134; G02B 2027/0138; G02B 2027/0154

(57) ABSTRACT

An extended reality (XR) headset assembly is described herein. The XR headset assembly includes a headset adapted to be worn by a user. A display system is coupled to the imaging equipment housing and is configured to display a display screen including computer-generated images thereon. A digital optical loupes imaging assembly is mounted above the display system and includes a pair of 3-dimensional (3D) imaging sensor assemblies spaced along the transverse axis and an illumination assembly positioned between the 3D imaging sensor assemblies. A controller is coupled to the digital optical loupes imaging assembly and the display system, and includes one or more processors programmed to display computer-generated images on the display system using image data received from the digital optical loupes imaging assembly.

### CROSS REFERENCE TO RELATED APPLICATIONS

This application claims the benefit of U.S. Provisional Application Ser. No. 63/676,791, filed Jul. 29, 2024, and U.S. Provisional Application Ser. No. 63/679,015, filed Aug. 2, 2024, the disclosures of which are hereby incorporated by reference in their entirety.

### TECHNICAL FIELD

The present disclosure generally relates to wearable display apparatus and more particularly to a wearable display device that provides augmented reality (AR), mixed reality (MR), and extended reality (XR) viewing including digital optical loupes.

### BACKGROUND

Virtual image display has advantages for augmented reality (AR) presentation, including providing the capability for display of image content using a compact optical system that can be mounted on eyeglasses or goggles, generally positioned very close to the eye (Near-Eye Display) and allowing see-through vision, not obstructing the view of the outside world. Among virtual image display solutions for AR viewing are catadioptric optics that employ a partially transmissive curved mirror for directing image-bearing light to the viewer's eye and a partially reflective beam splitter for combining light generated at a 2D display with the real-world visible scene which forms a 3D image when viewed binocularly.

Vision correction applications have employed wearable display devices in order to enhance or compensate for loss of vision over portions of a subject's field of view (FOV). Support for these types of applications can require additional components and can introduce various factors related to wearability and usability that contribute to the overall complexity of the optical design and packaging.

Among challenges that must be addressed with wearable AR devices is obtaining sufficient brightness of the virtual image. The brightness may come from an image generator such as a Micro-OLED microdisplay (Self-luminous), LCOS (Reflective LCD), LCD (Transmissive LCD), or Micro-LED (Self-luminous) types of displays. Alternatively, Digital Light Processing (DLP) technologies may be used, or Laser Beam Splitting (LBS) techniques may be used. These may employ the techniques of Tunable-Polychromatic LEDs, Chip-first active-matrix micro LED displays using low temperature OTFT backplanes, or High PPI microLED displays with QD colour conversion.

Many types of AR systems, particularly those using pupil expansion, have reduced brightness and power efficiency. Measured in NITS or candelas per square meter (Cd/m2), brightness for the augmented imaging channel must be sufficient for visibility under some demanding conditions, such as visible when overlaid against a bright outdoor scene. Other optical shortcomings of typical AR display solutions include distortion, reduced see-through transmission, small eye box, and angular field of view (FOV) constraints.

Some types of AR solution employ pupil expansion as a technique for enlarging the viewer eye-box. However, pupil expansion techniques tend to overfill the viewer pupil which wastes light, providing reduced brightness, compromised resolution, and lower overall image quality.

Challenging physical and dimensional constraints with wearable AR apparatus include limits on component size, circuit board size, and positioning and, with many types of optical systems, the practical requirement for folding the optical path in order that the imaging system components be ergonomically disposed, unobtrusive, and aesthetically acceptable in appearance. Among aesthetic aspects, compactness is desirable, with larger horizontal than vertical dimensions.

Other practical considerations relate to positioning of the display components themselves. Organic Light-Emitting Diode (OLED) displays have a number of advantages for brightness and overall image quality, but can generate perceptible amounts of heat, which may have to be exhausted or minimized with heat sinks. For this reason, it is advisable to provide some distance and air space between an OLED display and the skin, particularly since it may be necessary to position these devices near the viewer's forehead or temples.

Still other considerations relate to differences between users of the wearable display, such as with respect to inter-pupil distance (IPD) and other variables related to the viewer's vision. Further, problems related to conflict between vergence depth and accommodation have not been adequately understood or addressed in the art.

It has proved challenging to wearable display designers to provide the needed image quality, while at the same time allowing the wearable display device to be comfortable and aesthetically pleasing and to allow maximum see-through and peripheral visibility, which distinguishes the model from virtual reality (VR). In addition, the design of system optics must allow wearer comfort in social situations, without awkward appearance that might discourage use in public. Providing suitable component housing for wearable eyeglass display devices has proved to be a challenge, making some compromises necessary. As noted previously, in order to meet ergonomic and other practical requirements, some folding of the optical path along one or both vertical and horizontal axes may be desirable.

The present invention addresses one or more of the aforementioned challenges.

### SUMMARY OF INVENTION

The Applicant's address the problem of advancing the art of AR/MR/XR display and addressing shortcomings of other proposed solutions, as outlined previously in the background section.

In one aspect of the present invention, an extended reality (XR) headset assembly is provided. The XR headset assembly includes a headset adapted to be worn by a user and including a support frame including a pair of opposing support arms extending along a longitudinal axis and spaced along a transverse axis perpendicular to the longitudinal axis and an imaging equipment housing coupled to a forward portion of the support frame and positioned adjacent a forehead of the user. A display system is coupled to the imaging equipment housing and is configured to display a display screen including computer-generated images thereon. A digital optical loupes imaging assembly is mounted within the equipment housing positioned above the display system. The digital optical loupes imaging assembly includes a pair of 3-dimensional (3D) imaging sensor assemblies spaced along the transverse axis and an illumination assembly positioned between the 3D imaging sensor assemblies. A controller is coupled to the digital optical loupes imaging assembly and the display system, and includes one or more processors programmed to display computer-generated images on the display system using image data received from the digital optical loupes imaging assembly.

In another aspect of the present invention, a method of assembling an XR headset assembly is provided. The method includes providing a headset adapted to be worn by a user and including a support frame including a pair of opposing support arms extending along a longitudinal axis and spaced along a transverse axis perpendicular to the longitudinal axis and coupling an imaging equipment housing to a forward portion of the support frame and positioned adjacent a forehead of the user. A display system is coupled to the imaging equipment housing and is configured to display a display screen including computer-generated images thereon. A digital optical loupes imaging assembly is mounted within the equipment housing positioned above the display system. The digital optical loupes imaging assembly includes a pair of 3D imaging sensor assemblies spaced along the transverse axis and an illumination assembly positioned between the 3D imaging sensor assemblies. A controller is coupled to the digital optical loupes imaging assembly and the display system, and including one or more processors programmed to display computer-generated images on the display system using image data received from the digital optical loupes imaging assembly.

### BRIEF DESCRIPTION OF THE DRAWINGS

Non-limiting and non-exhaustive embodiments of the present invention are described with reference to the following figures. Other advantages of the present disclosure will be readily appreciated, as the same becomes better understood by reference to the following detailed description when considered in connection with the accompanying drawings wherein:

FIGS. 1-5 are schematic views of an extended reality (XR) headset assembly including a digital optical loupes imaging assembly, according to embodiments of the present invention;

FIGS. 6-10 are partial schematic views of the XR headset assembly shown in FIGS. 1-5;

FIGS. 11-13 are partial schematic views of the digital optical loupes imaging assembly including a pair of 3-dimensional (3D) imaging sensor assemblies and a convergence adjustment assembly;

FIGS. 14-15 are schematic views of the 3D imaging sensor assembly shown in FIGS. 11-13;

FIGS. 16-17 are perspective views of the XR headset assembly shown in FIGS. 1-5 including optical engine assemblies including pancake lens assemblies, according to embodiments of the present invention;

FIGS. 18-20 are schematic views of the pancake lens assembly shown in FIGS. 16-17;

FIG. 21 is a functional block diagram of the XR headset assembly shown in FIGS. 1-5;

FIGS. 22-25 are perspective views of the XR headset assembly shown in FIGS. 1-5 including the optical engine assemblies including near-eye pupil forming catadioptric optical engines, according to embodiments of the present invention;

FIGS. 26-34 are schematic views of the near-eye pupil forming catadioptric optical engines shown in FIGS. 22-25; and

FIGS. 35-38 are schematic views of near-eye pupil forming catadioptric optical engines that may be used with the XR headset shown in FIGS. 22-25, according to embodiments of the present invention.

Corresponding reference characters indicate corresponding parts throughout the drawings.

### DETAILED DESCRIPTION

With reference to the drawings, and in operation, the present invention is directed towards an extended reality (XR) headset including a digital optical loupes imaging assembly that may be worn by a user, and method of assembling the XR headset with the digital optical loupes imaging assembly. The following is a detailed description of the preferred embodiments of the disclosure, reference being made to the drawings in which the same reference numerals identify the same elements of structure in each of the several figures.

While the devices and methods have been described with a certain degree of particularity, it is to be noted that many modifications may be made in the details of the construction and the arrangement of the devices and components without departing from the spirit and scope of this disclosure. It is understood that the devices and methods are not limited to the embodiments set forth herein for purposes of exemplification. It will be apparent to one having ordinary skill in the art that the specific detail need not be employed to practice according to the present disclosure. In other instances, well-known materials or methods have not been described in detail in order to avoid obscuring the present disclosure.

Reference throughout this specification to “one embodiment,” “an embodiment,” “one example,” or “an example” means that a particular feature, structure, or characteristic described in connection with the embodiment or example is included in at least one embodiment of the present disclosure. Thus, appearances of the phrases “in one embodiment,” “in an embodiment,” “one example,” or “an example” in various places throughout this specification are not necessarily all referring to the same embodiment or example. Furthermore, the particular features, structures, or characteristics may be combined in any suitable combinations and/or sub-combinations in one or more embodiments or examples.

Several (or different) elements discussed herein and/or claimed are described as being “coupled,” “in communication with,” “integrated,” or “configured to be in communication with” or a “system” or “subsystem” thereof. This terminology is intended to be non-limiting and, where appropriate, be interpreted to include, without limitation, wired and wireless communication using any one or a plurality of a suitable protocols, as well as communication methods that are constantly maintained, are made on a periodic basis, and/or made or initiated on an as-needed basis.

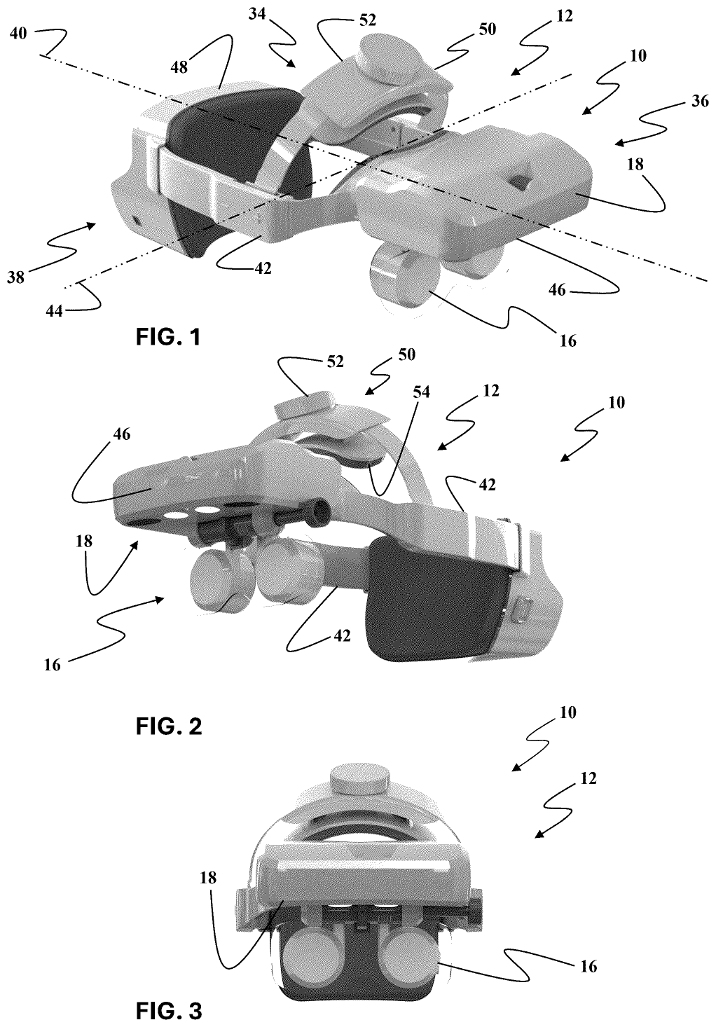

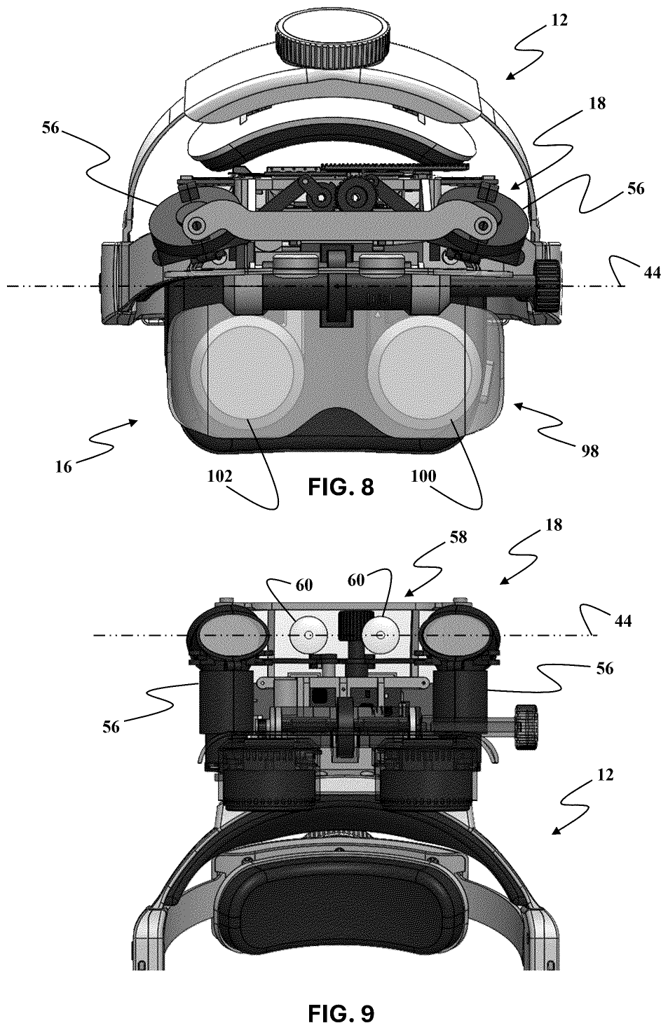

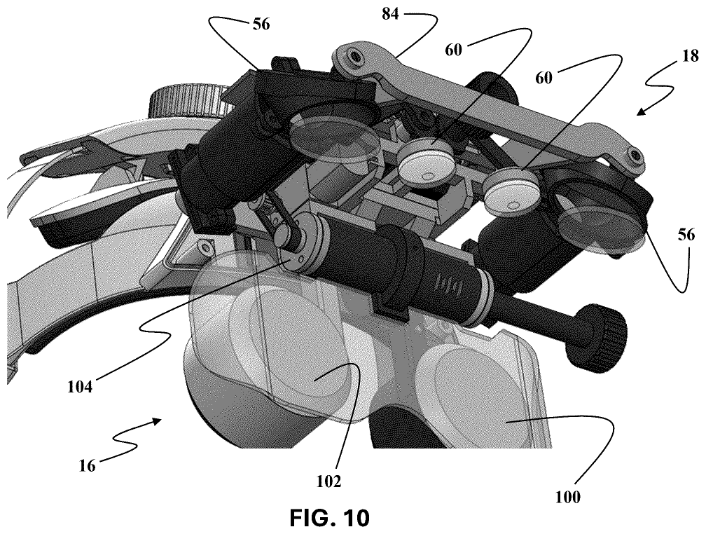

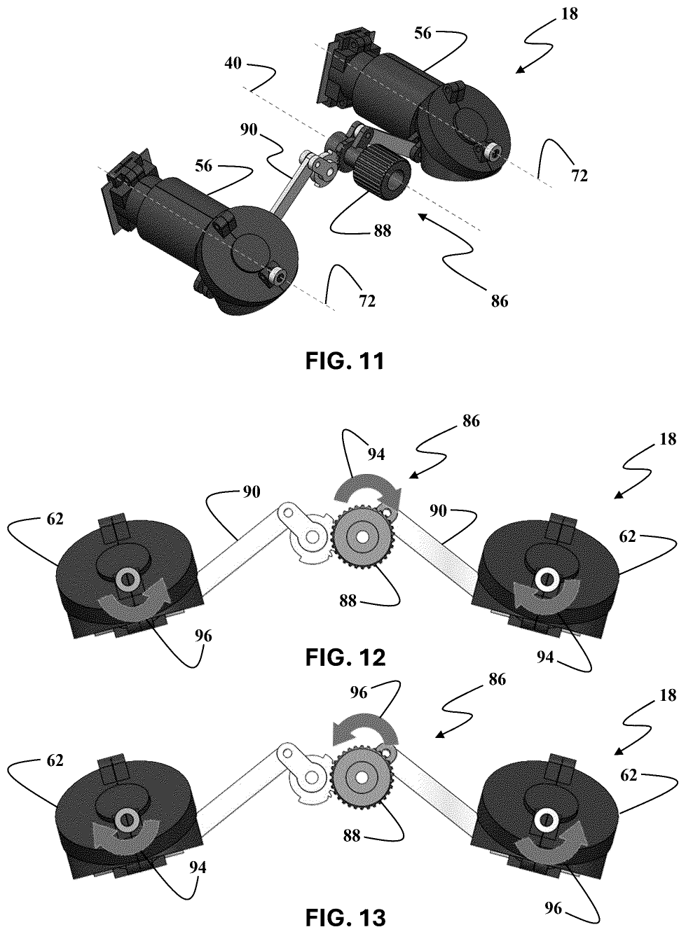

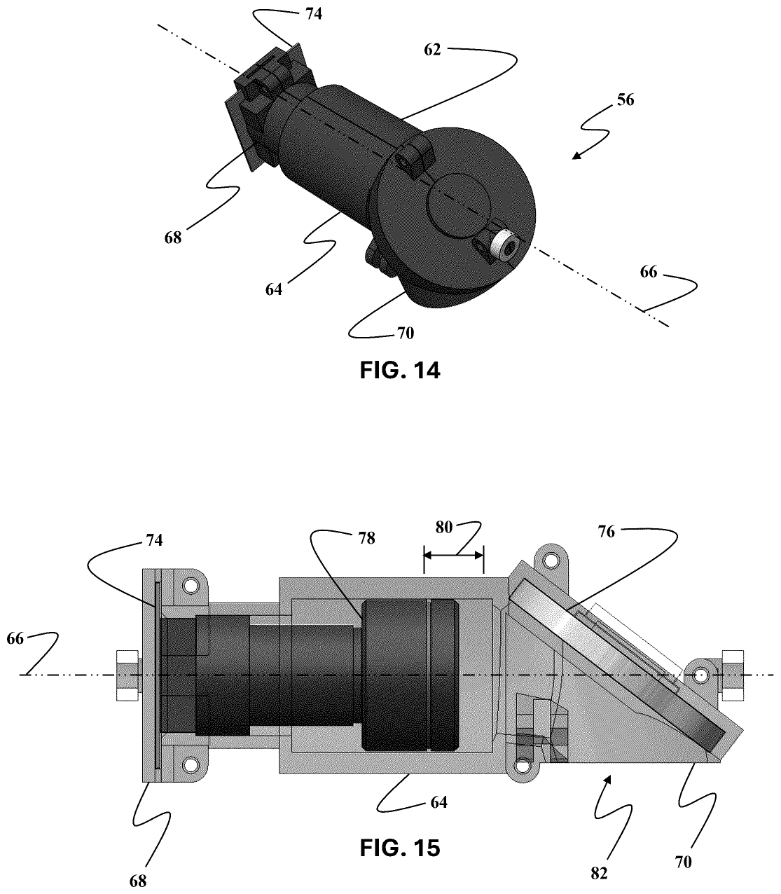

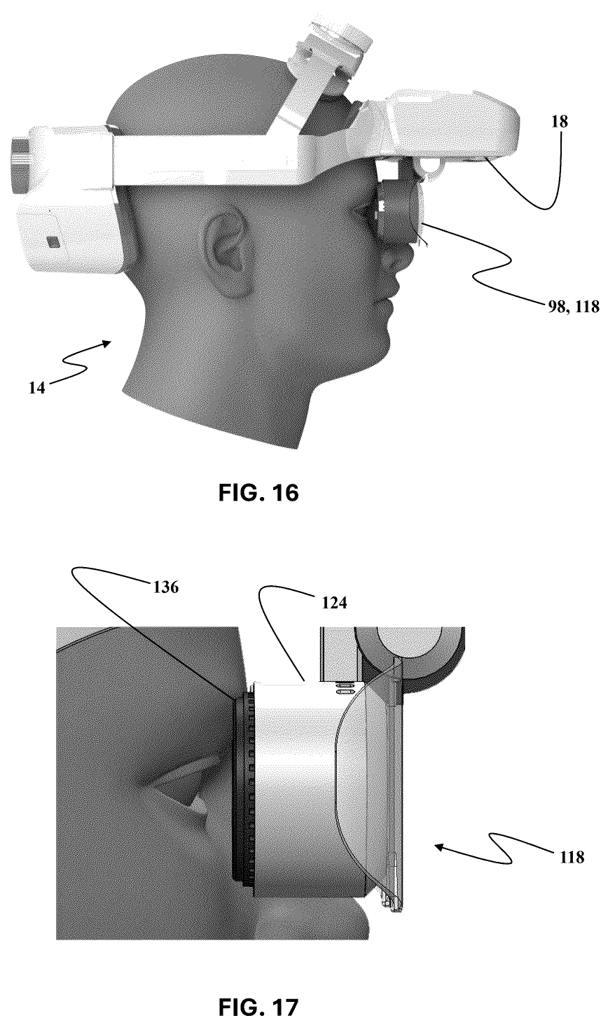

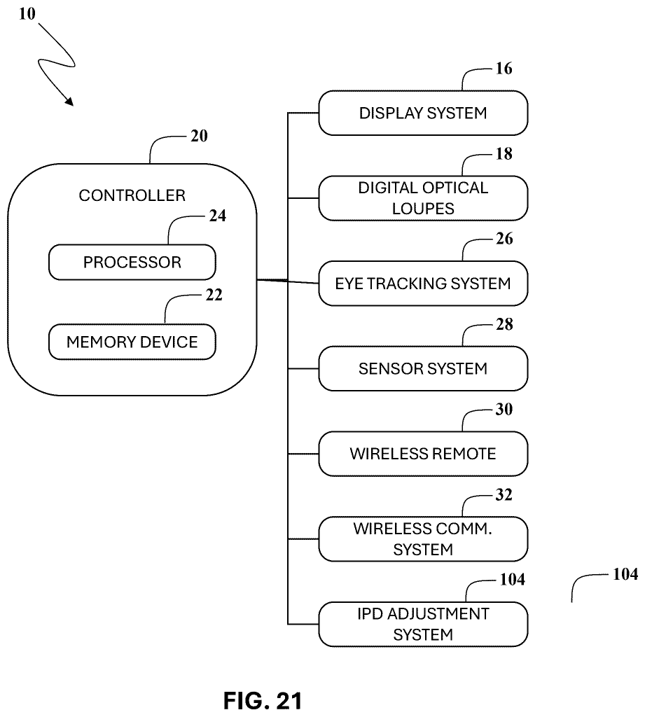

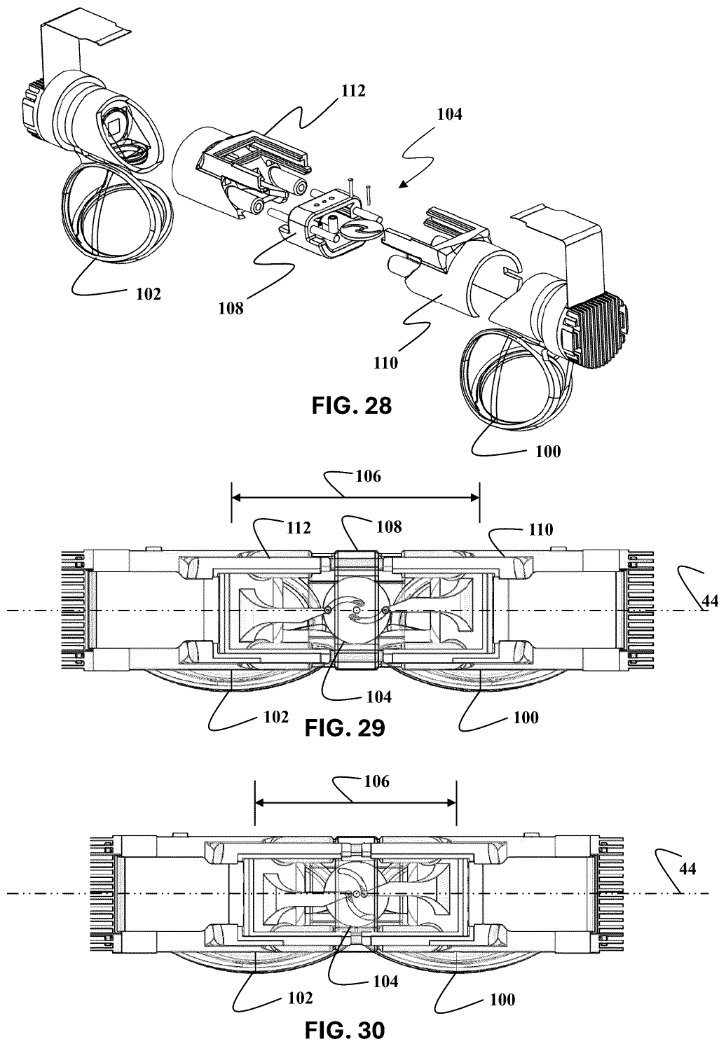

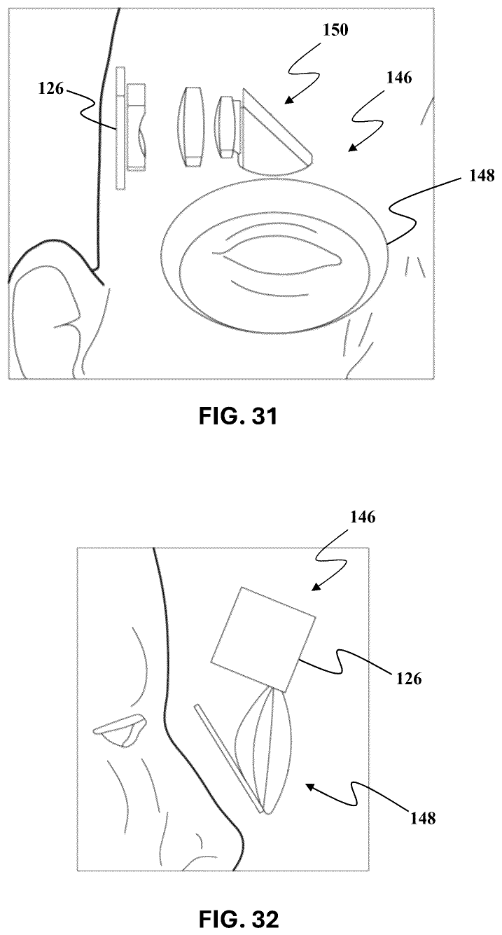

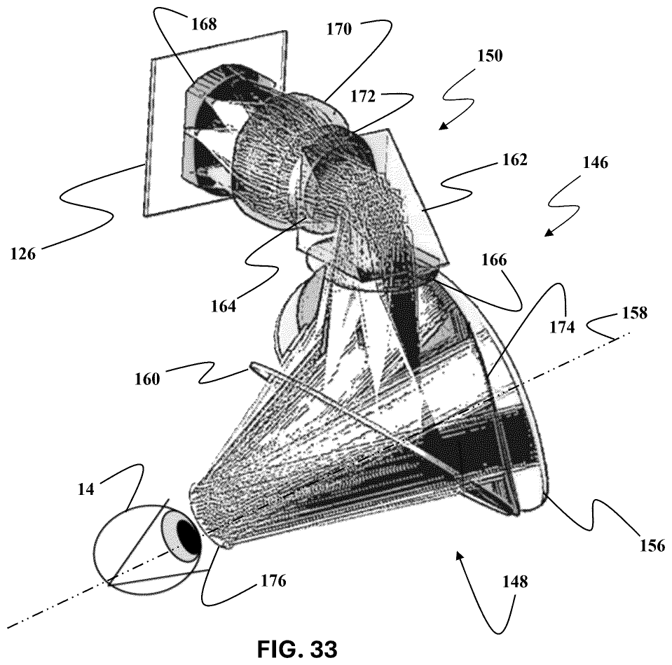

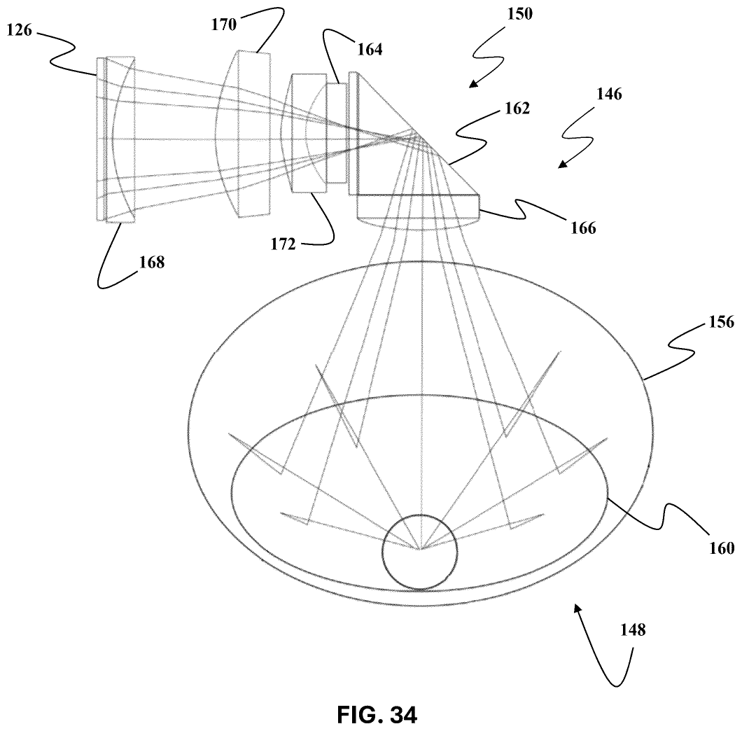

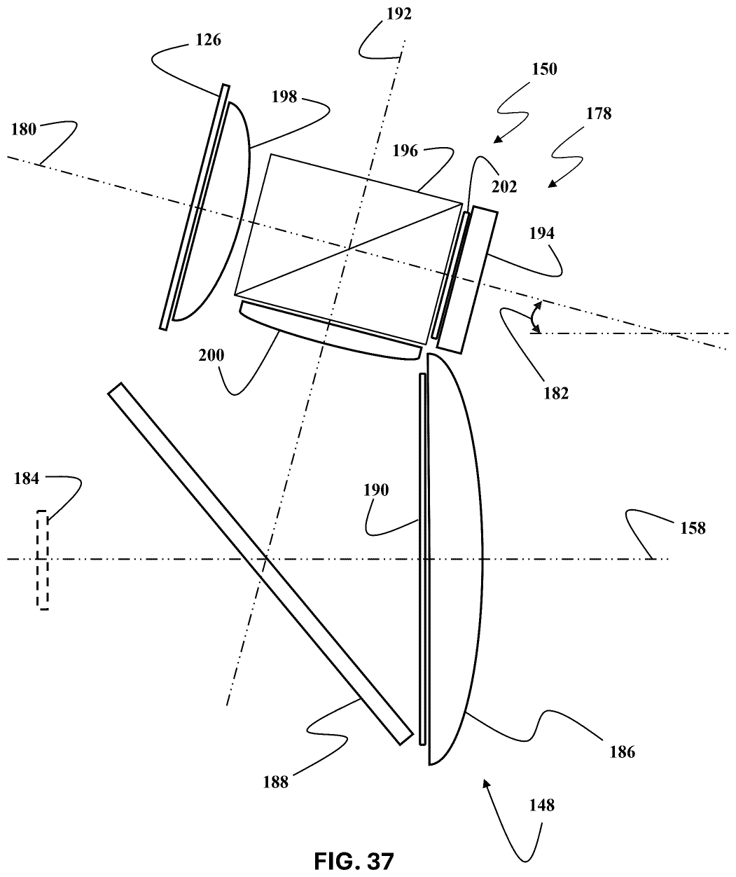

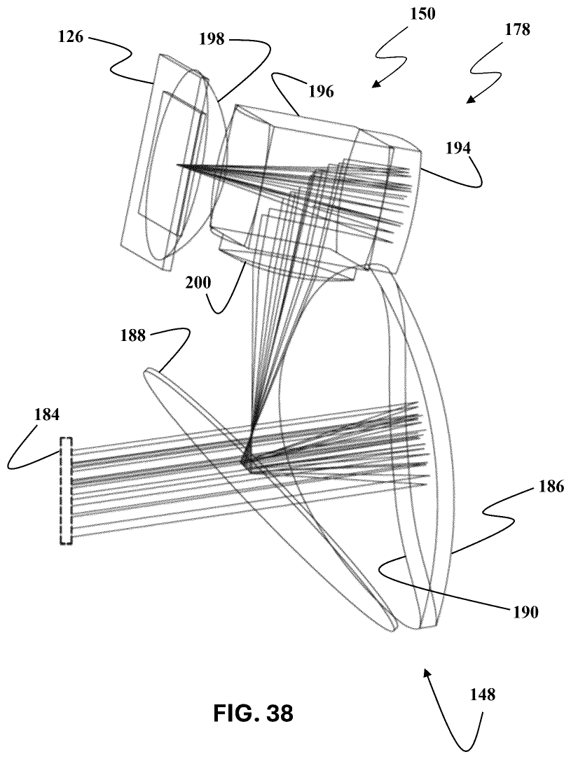

Referring to FIGS. 1-38, in the illustrated embodiment, the present invention includes an extended reality (XR) headset assembly 10 that includes a headset 12 that is adapted to be worn by a user 14, a display system 16 mounted to the headset 12 and configured to display a display screen including computer-generated images thereon, a digital optical loupes imaging assembly 18 mounted to the headset 12, and a controller 20 coupled to the digital optical loupes imaging assembly 18 and the display system 16 for displaying computer-generated images on the display system 16 using image data received from the digital optical loupes imaging assembly 18.

The controller 20 includes a memory device 22 for storing computer-executable instructions thereon, and one or more processors 24 programmed to execute the computer-executable instructions to perform algorithms for displaying computer-generated images on the display system 16 using image data received from the digital optical loupes imaging assembly 18. In some embodiments, the XR headset assembly 10 may also include an eye tracking system 26 mounted to the headset 12 and coupled to the controller 20 for use in tracking the user's eye movement and determining position of the user's gaze, a sensor system 28 mounted to the headset 12 and coupled to the controller 20 for determining a position and/or movement of the user's head and/or the headset 12, and a wireless hand-held remote 30 that wirelessly communicates with the controller 20 via a wireless communication system 32 such as, for example, cellular frequencies, Radio Frequencies, WiFi, Bluetooth or Bluetooth Low Energy, to enable a user to operate the XR headset assembly 10.

The headset 12 includes a support frame 34 that extends between a forward portion 36 and a rear portion 38 along a longitudinal axis 40. The support frame 34 includes a pair of opposing support arms 42 extending along the longitudinal axis 40 and spaced along a transverse axis 44 perpendicular to the longitudinal axis 40, and an imaging equipment housing 46 that is coupled to the forward portion 36 of the support frame 34 and is positioned adjacent to a forehead of the user 14. A battery pack assembly 48 is coupled to the support arms 42 at the rear portion 38 of the support frame 34 and is positioned adjacent the back of the user's head. A curved upper support assembly 50 extends between the support arms 42 and is adapted to contact a top portion of the user's head to facilitate supporting the XR headset 12 from the user's head. The curved upper support assembly 50 includes an adjustable-length strap assembly 52 and a positioning pad 54 coupled to adjustable-length strap assembly 52 and contacting the user's head when worn by the user 14.

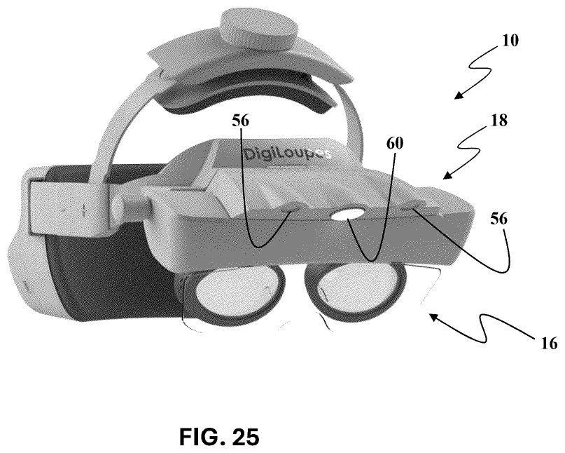

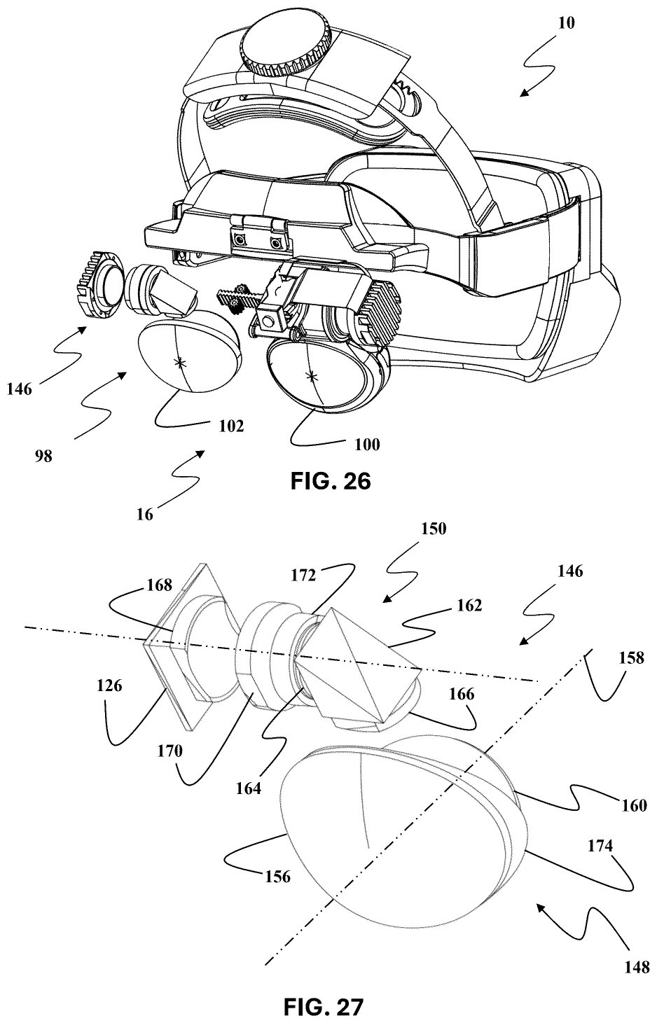

The digital optical loupes imaging assembly 18 is mounted within the imaging equipment housing 46 and is positioned above the display system 16. The digital optical loupes imaging assembly 18 includes a pair of 3-dimensional (3D) imaging sensor assemblies 56 that are spaced along the transverse axis 44, and an illumination assembly 58 that is positioned between the 3D imaging sensor assemblies 56. In some embodiments, as shown in FIGS. 1-10, the illumination assembly 58 includes a pair of light-emitting diodes (LEDs) 60 that are spaced along the transverse axis 44 between the pair of 3D imaging sensor assemblies 56. In other embodiments, as shown in FIG. 25, the illumination assembly 58 includes a single LED 60 positioned between the pair of 3D imaging sensor assemblies 56.

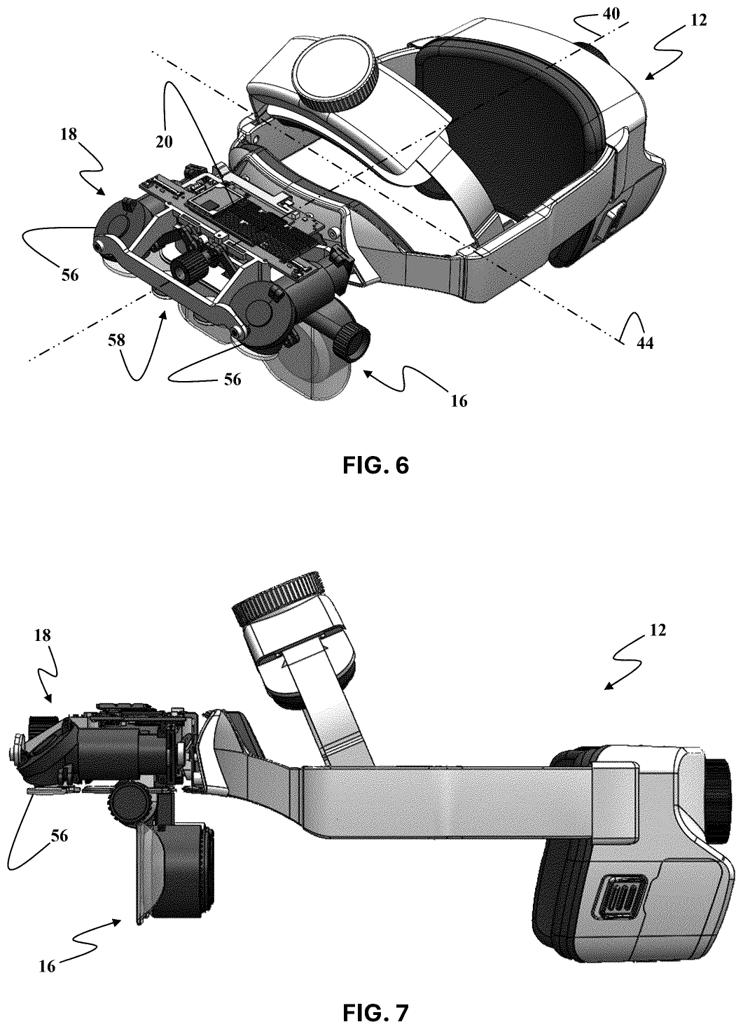

As shown in FIGS. 6-15, in the illustrated embodiment, each 3D imaging sensor assembly 56 includes a camera barrel assembly 62. The camera barrel assembly 62 includes a camera housing 64 that extends along a centerline axis 66 between a first end 68 and an opposite second end 70, and is mounted to the headset 12 such that the camera barrel assembly 62 is pivotable about a pivot axis 72 parallel to the centerline axis 66. An image sensor 74 is mounted within the camera housing 64 adjacent the first end 68 and a mirror 76 is mounted within the camera housing 64 adjacent the opposite second end 70. The mirror 76 is orientated at an oblique angle with respect to the image sensor 74 and is spaced a distance from the image sensor 74 along the centerline axis 66. A camera lens assembly 78 is mounted within the camera housing 64 and is positioned between the image sensor 74 and the mirror 76 along the centerline axis 66 to direct light rays from the mirror 76 towards the image sensor 74. The camera lens assembly 78 is positionable a distance 80 along the centerline axis 66 to facilitate adjusting a focus and magnification of the camera barrel assembly 62. The mirror 76 is configured to direct light rays received through an opening 82 defined near the second end 70 of the camera housing 64 towards the image sensor 74 through the camera lens assembly 78.

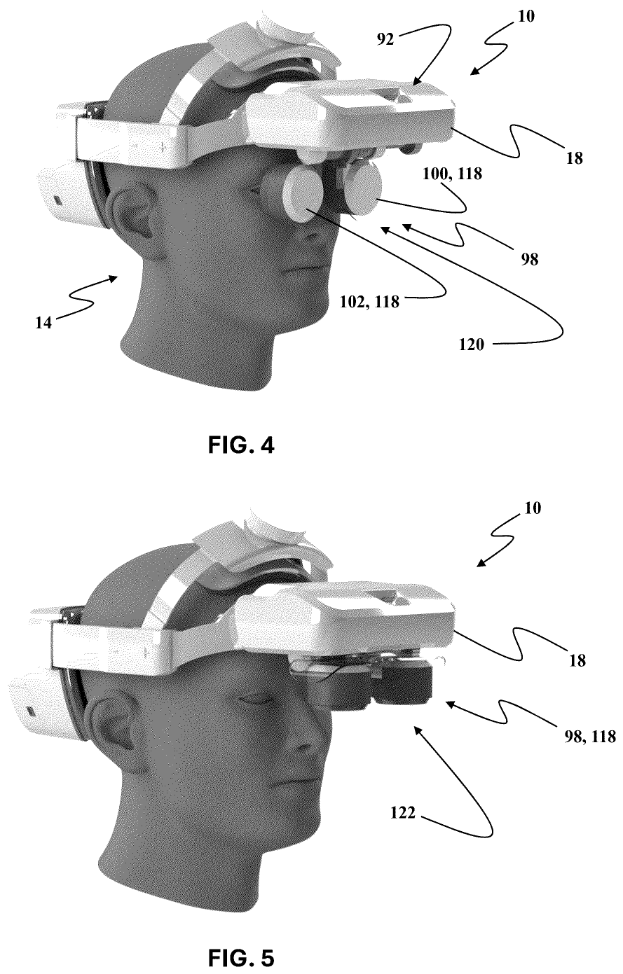

The digital optical loupes imaging assembly 18 may also include a stationary support bracket 84 that is mounted within the imaging equipment housing 46. Each camera barrel assembly 62 is pivotably coupled to the stationary support bracket 84 to support each camera barrel assembly 62 from the imaging equipment housing 46. A convergence adjustment assembly 86 is mounted within the imaging equipment housing 46 and is coupled to each camera barrel assembly 62 to adjust a rotational orientation of each camera barrel assembly 62 about the corresponding pivot axis 72. The convergence adjustment assembly 86 includes an adjustment dial 88 and a pair of opposing adjustment arms 90 extending outwardly from the adjustment dial 88. The adjustment dial 88 is positioned between the camera barrel assemblies 62 and is accessible through an opening 92 (shown in FIG. 4) defined along a top surface of the imaging equipment housing 46. The adjustment arms 90 extend outwardly from the adjustment dial 88 and are coupled to each camera barrel assembly 62 such that a rotation of the adjustment dial 88 causes each camera barrel assembly 62 to rotate about a corresponding pivot axis 72 in a mirrored relationship. For example, as shown in FIGS. 12 and 13, a rotation of the adjustment dial 88 in a clockwise direction 94 causes a first camera barrel assembly 62 to rotate in a clockwise direction 94 and a second camera barrel assembly 62 to rotate in a counter-clockwise direction 96, and a rotation of the adjustment dial 88 in the counter-clockwise direction 96 causes the first camera barrel assembly 62 to rotate in the counter-clockwise direction 96 and the second camera barrel assembly 62 to rotate in the clockwise direction 94.

The display system 16 is coupled to the imaging equipment housing 46 and is configured to display a display screen including computer-generated images thereon. The display system 16 includes a pair of optical engine assemblies 98 that are spaced along the transverse axis 44 and include a left-eye optical engine assembly 100 positioned adjacent a left eye of the user 14 and a right-eye optical engine assembly 102 positioned adjacent a right eye of the user 14.

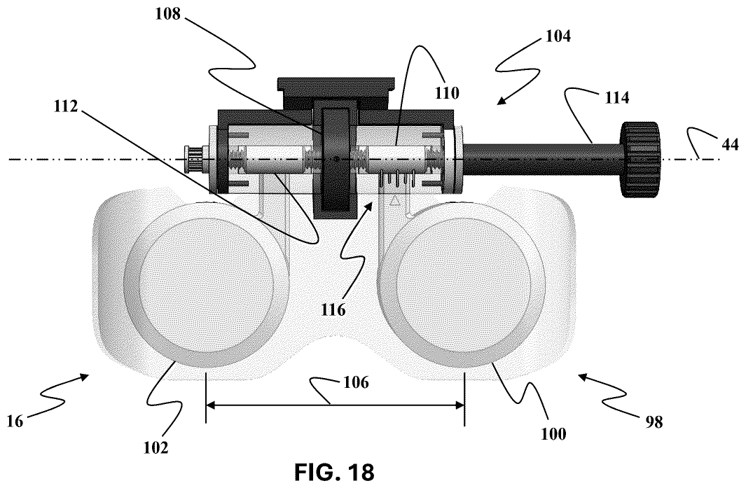

The display system 16 may also include an inter-pupil distance (IPD) adjustment system 104 that is coupled to the left-eye and right-eye optical engine assemblies 100, 102 and configured to adjust the distance 106 between the left-eye and right-eye optical engine assemblies 100, 102 along the transverse axis 44 to facilitate accommodating the IPD of the user. As shown in FIGS. 18 and 28-30, the IPD adjustment system 104 includes a stationary center support 108 mounted to the headset support frame 34, a left transport apparatus 110 slideably mounted to the stationary center support 108 and coupled to the left-eye optical engine assembly 100 for supporting the left-eye optical engine assembly 100 from the stationary center support 108, and a right transport apparatus 112 slideably mounted to the stationary center support 108 and coupled to the right-eye optical engine assembly 102 for supporting the right-eye optical engine assembly 102 from the stationary center support 108. The IPD adjustment system 104 may also include an actuator 114 that is operable by the controller 20 and that is configured to selectively move the left transport apparatus 110 and the right transport apparatus 112 along the transverse axis 44 to adjust an inter-pupil spacing between the left-eye optical engine assembly 100 and the right-eye optical engine assembly 102. The IPD adjustment system 104 may also include an IPD distance indicator 116 affixed to the left and/or right transport apparatus 110, 112 indicating a current inter-pupil distance of the IPD adjustment system 104

As shown in FIGS. 1-10 and 16-20, in some embodiments, each optical engine assembly 98 may include a pancake lens assembly 118 that is pivotably coupled to the headset 12 and is positionable between a deployed position 120 (shown in FIG. 4) with the pancake lens assemblies 118 positioned in front of the user's eyes, and stowed position 122 with the pancake lens assemblies 118 pivoted to a position above the user's eyes. The pancake lens assembly 118 includes a lens housing 124 containing an image generator 126 positioned at a first end 128 and a lens assembly 130 positioned near a second end 132 along an optical axis 134. In the deployed position 120, the lens assembly 130 is positioned between the image generator 126 and the user's eye along the optical axis 134.

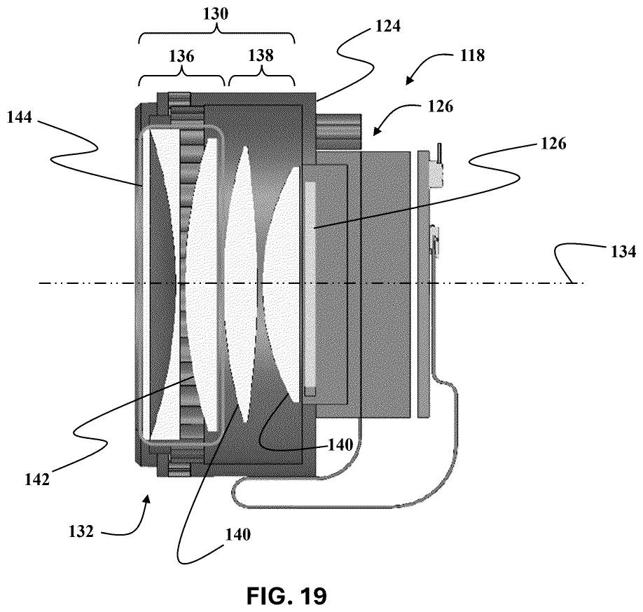

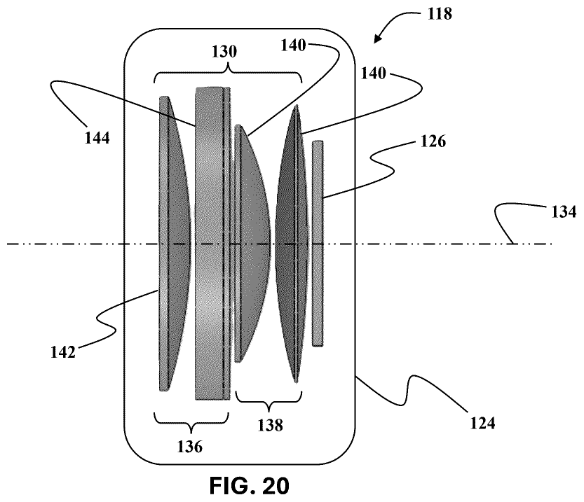

The lens assembly 130 includes a diopter adjustment lens group 136 that is movable along the optical axis 134 and a pair 138 of opposing stationary singlet lenses 140 positioned between the diopter adjustment lens group 136 and the image generator 126. The diopter adjustment lens group 136 includes a singlet lens 142 and a doublet lens 144. In some embodiments, as shown in FIG. 19, the singlet lens 142 is positioned between the doublet lens 144 and the pair 138 of opposing stationary singlet lenses 140 along the optical axis 134. In other embodiments, as shown in FIG. 20, the doublet lens 144 is positioned between the singlet lens 142 and the pair 138 of opposing stationary singlet lenses 140 along the optical axis 134.

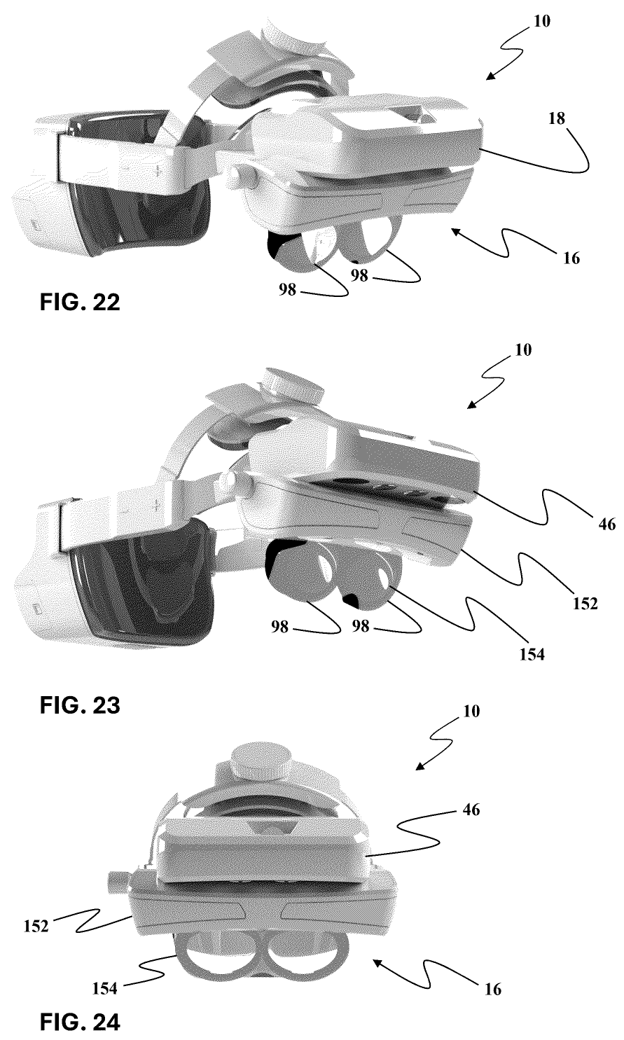

In some embodiments, as shown in FIGS. 22-38, each optical engine assembly 98 may include a near-eye pupil forming catadioptric optical engine 146. For example, as shown in FIGS. 27-34, the near-eye pupil forming catadioptric optical engine 146 may include an image generator 126 forming a 2D image, an optical imaging assembly 148, and an optical image relay assembly 150. An optical module housing 152 is coupled to the support frame 34 and houses the image generator 126 and the optical image relay assembly 150 therein. An imaging support frame 154 extends downward from the optical module housing 152 to support the optical imaging assembly 148 from the optical module housing 152.

The optical imaging assembly 148 includes a partially transmissive mirror 156 disposed along a first optical axis 158 orientated along an optical path of the user 14 and having a curved reflective surface, and a beam splitter 160 disposed along the first optical axis 158 between an eye of the user and the partially transmissive mirror 156 to reflect light toward the curved mirror surface.

The optical image relay assembly 150 is configured to conjugate the formed 2D image at the image generator 126 to a curved focal surface of the partially transmissive mirror 156 defined between the curved reflective surface of the partially transmissive mirror 156 and the beam splitter 160. The optical image relay assembly 150 includes a prism 162, a first plano-aspheric lens 164 in optical contact with the prism 162, and a second plano-aspheric lens 166 in optical contact with the prism 162. For example, the prism 162 includes an input surface, an output surface, and a folding surface extending between the input and output surfaces. The folding surface is configured for folding an optical path for light generated by the image generator 126 with an aperture stop for the optical image relay assembly 150 lying within the prism 162. The first plano-aspheric lens 164 is in optical contact against the prism input surface and is configured to guide light from the image generator 126 toward the folding surface. The second plano-aspheric lens 166 is in optical contact against the prism output surface and is configured to direct the light towards the beam splitter 160.

The optical image relay assembly 150 may also include a concave-plano field lens 168 that shapes the light from the image generator 126, providing a beam to a meniscus singlet lens 170. From the meniscus singlet lens 170, the imaging light goes to a doublet 172 having a concave/convex flint glass lens cemented to a crown glass lens. An aspheric plano-convex lens 164 is in optical contact with the input face of the prism 162, and the second plano-aspheric lens 166 is cemented to the output face of the prism 162. This cemented arrangement facilitates alignment of these optical components. The hypotenuse or turning surface of the prism 162 is essentially the relay (and system) aperture stop. An intermediate image is formed in the shape and location of the focal surface of the curved mirror 156. A cylindrically curved quarter-wave plate (QWP) 174 may be positioned between the mirror 156 and the beam splitter 160. The curvature of the QWP 174 helps to reduce variations of the retardation imparted to the image-bearing light by the QWP 174 over the field of view of the large exit pupil 176. The image generator 126 may be a display that emits light, such as an organic light-emitting device (OLED) array or a liquid crystal array or a micro-LED array with accompanying lenslets, or some other type of spatial light modulator useful for image generation. Additional details of the near-eye pupil forming catadioptric optical engine 146, the eye tracking system 26, and the sensor system 28, which may be used in the present invention, are described in U.S. patent application Ser. No. 17/139,167 to David Kessler et al., filed Dec. 31, 2020, titled “Wearable Pupil-Forming Apparatus”, which is incorporated herein by reference in its entirety.

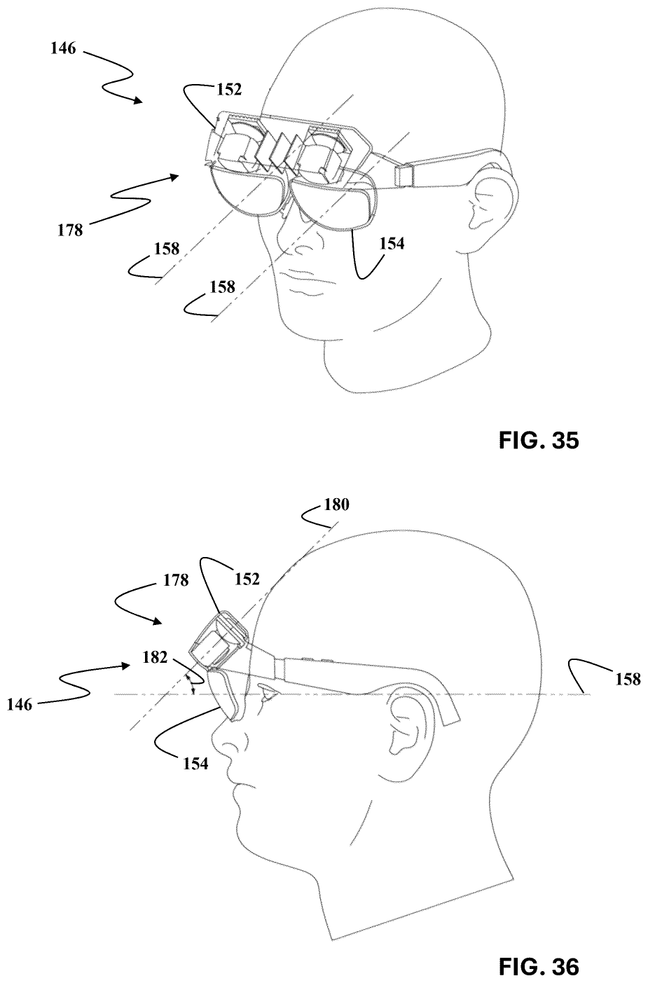

In another embodiment, as shown in FIGS. 35-38, the near-eye pupil forming catadioptric optical engine 146 includes a compact catadioptric optical engine 178 that includes the optical imaging assembly 148 mounted to the imaging support frame 154 and orientated along the first optical axis 158 and the optical image relay assembly 150 positioned within the optical module housing 152 and orientated along a second optical axis 180 that is orientated at an oblique vertical angle 182 from the first optical axis 158. When worn by the user, the first optical axis 158 is aligned with the optical path of the corresponding eye of the user.

The optical imaging assembly 148 is orientated along the first optical axis 158 and is configured to form an exit pupil 184 along the first optical axis 158 orientated along an optical path of the user for viewing the 2D image by the user. The optical imaging assembly 148 includes a spherical combiner 186 and a first beam splitter 188 that is positioned between the spherical combiner 186 and the exit pupil 184.

In some embodiments, the first beam splitter 188 includes a wire grid beam splitter. In addition, the optical imaging assembly 148 may also include a cylindrically curved quarter wave plate film 190 that is orientated between the spherical combiner 186 and the wire grid beam splitter 188.

The optical image relay assembly 150 is configured to conjugate the formed 2D image towards the first beam splitter 188 along a third optical axis 192 that is perpendicular to the second optical axis 180. For example, the optical image relay assembly 150 may be configured to conjugate the formed 2D image from the image generator 126 towards the first beam splitter 188 along the third optical axis 192 that is perpendicular to the second optical axis 180. The optical image relay assembly 150 includes a mangin mirror 194, a polarizing beam splitter 196, a field lens 198, and an aspheric lens 200. The mangin mirror 194 is positioned along the second optical axis 180 and is configured to reflect the 2D image along the second optical axis 180 and back towards the image generator 126. The polarizing beam splitter 196 is positioned along the second optical axis 180 between the mangin mirror 194 and the image generator 126 for transmitting the reflected 2D image from the mangin mirror 194 towards the third optical axis 192. The field lens 198 is positioned along the second optical axis 180 between the polarizing beam splitter 196 and the image generator 126 for transmitting the 2D image from the image generator 126 to the polarizing beam splitter 196 along the second optical axis 180. The aspheric lens 200 is positioned along the third optical axis 192 between the polarizing beam splitter 196 and the optical imaging assembly 148 for transmitting the reflected 2D image from the polarizing beam splitter 196 to the first beam splitter 188.

In some embodiments, the optical image relay assembly 150 may include a quarter wave plate 202 that is cemented between the polarizing beam splitter 196 and the mangin mirror 194.

Additional details of the compact catadioptric optical engine 178, which may be used in the present invention, are described in U.S. patent application Ser. No. 18/531,248 to David Kessler at al., filed Dec. 6, 2023, titled “Augmented Reality Near-Eye Pupil-Forming Catadioptric Optical Engine in Glasses Format”, which is incorporated herein by reference in its entirety.

The present invention is also directed to a method of assembling the XR headset assembly 10. The method includes providing a headset 12 adapted to be worn by a user and including a support frame 34 including a pair of opposing support arms 42 extending along the longitudinal axis 40 and spaced along the transverse axis 44, coupling the imaging equipment housing 46 to the forward portion 36 of the support frame 34, coupling the display system 16 to the imaging equipment housing 46, mounting the digital optical loupes imaging assembly 18 within the imaging equipment housing 46, and coupling the controller 20 to the digital optical loupes imaging assembly 18 and the display system 16 to display computer-generated images on the display system 16 using image data received from the digital optical loupes imaging assembly 18.

While the devices and methods have been described with a certain degree of particularity, it is to be noted that many modifications may be made in the details of the construction and the arrangement of the devices and components without departing from the spirit and scope of this disclosure. It is understood that the devices and methods are not limited to the embodiments set forth herein for purposes of exemplification. It will be apparent to one having ordinary skill in the art that the specific detail need not be employed to practice according to the present disclosure. In other instances, well-known materials or methods have not been described in detail in order to avoid obscuring the present disclosure.

Reference throughout this specification to “one embodiment,” “an embodiment,” “one example,” or “an example” means that a particular feature, structure, or characteristic described in connection with the embodiment or example is included in at least one embodiment of the present disclosure. Thus, appearances of the phrases “in one embodiment,” “in an embodiment,” “one example,” or “an example” in various places throughout this specification are not necessarily all referring to the same embodiment or example. Furthermore, the particular features, structures, or characteristics may be combined in any suitable combinations and/or sub-combinations in one or more embodiments or examples.

A controller, computing device, or computer, such as described herein, includes at least one or more processors or processing units and a system memory. The controller typically also includes at least some form of computer readable media. By way of example and not limitation, computer readable media may include computer storage media and communication media. Computer storage media may include volatile and nonvolatile, removable and non-removable media implemented in any method or technology that enables storage of information, such as computer readable instructions, data structures, program modules, or other data. Communication media typically embody computer readable instructions, data structures, program modules, or other data in a modulated data signal such as a carrier wave or other transport mechanism and include any information delivery media. Those skilled in the art should be familiar with the modulated data signal, which has one or more of its characteristics set or changed in such a manner as to encode information in the signal. Combinations of any of the above are also included within the scope of computer readable media.

The order of execution or performance of the operations in the embodiments of the invention illustrated and described herein is not essential, unless otherwise specified. That is, the operations described herein may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

In some embodiments, a processor, as described herein, includes any programmable system including systems and microcontrollers, reduced instruction set circuits (RISC), application specific integrated circuits (ASIC), programmable logic circuits (PLC), and any other circuit or processor capable of executing the functions described herein. The above examples are exemplary only, and thus are not intended to limit in any way the definition and/or meaning of the term processor.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Other aspects and features of the present invention can be obtained from a study of the drawings, the disclosure, and the appended claims. The invention may be practiced otherwise than as specifically described within the scope of the appended claims. It should also be noted, that the steps and/or functions listed within the appended claims, notwithstanding the order of which steps and/or functions are listed therein, are not limited to any specific order of operation.

Although specific features of various embodiments of the invention may be shown in some drawings and not in others, this is for convenience only. In accordance with the principles of the invention, any feature of a drawing may be referenced and/or claimed in combination with any feature of any other drawing.

The invention has been described in detail with particular reference to a presently preferred embodiment, but it will be understood that variations and modifications can be effected within the spirit and scope of the disclosure. The presently disclosed embodiments are therefore considered in all respects to be illustrative and not restrictive. The scope of the invention is indicated by any appended claims, and all changes that come within the meaning and range of equivalents thereof are intended to be embraced therein.

What is claimed is:

1. An extended reality (XR) headset assembly comprising:
a headset adapted to be worn by a user and including:
a support frame including a pair of opposing support arms extending along a longitudinal axis and spaced along a transverse axis perpendicular to the longitudinal axis; and
an imaging equipment housing coupled to a forward portion of the support frame and positioned adjacent a forehead of the user;
a display system coupled to the imaging equipment housing and configured to display a display screen including computer-generated images thereon;
a digital optical loupes imaging assembly mounted within the imaging equipment housing positioned above the display system, the digital optical loupes imaging assembly including a pair of 3-dimensional (3D) imaging sensor assemblies spaced along the transverse axis and an illumination assembly positioned between the 3D imaging sensor assemblies; and
a controller coupled to the digital optical loupes imaging assembly and the display system, and including one or more processors programmed to display computer-generated images on the display system using image data received from the digital optical loupes imaging assembly.

2. The XR headset assembly of claim 1, wherein the illumination assembly includes a pair of light-emitting diodes (LEDs) spaced along the transverse axis between the pair of 3D imaging sensor assemblies.

3. The XR headset assembly of claim 1, wherein each 3D imaging sensor assembly includes:
a camera barrel assembly including:
a camera housing extending along a centerline axis between a first end and an opposite second end;
an image sensor mounted within the camera housing adjacent the first end;
a mirror mounted within the camera housing adjacent the opposite second end at an oblique angle with respect to the image sensor and spaced a distance from the image sensor along the centerline axis; and
a camera lens assembly mounted within the camera housing and positioned between the image sensor and the mirror along the centerline axis to direct light rays from the mirror towards the image sensor.

4. The XR headset assembly of claim 1, wherein the camera lens assembly is positionable along the centerline axis to facilitate adjusting a focus and magnification of the camera barrel assembly.

5. The XR headset assembly of claim 1, wherein the camera barrel assembly is mounted to the headset such that the camera barrel assembly is pivotable about a pivot axis parallel to the centerline axis.

6. The XR headset assembly of claim 5, wherein the digital optical loupes imaging assembly includes:
a stationary support bracket mounted within the imaging equipment housing, each camera barrel assembly pivotably coupled to the stationary support bracket to support each camera barrel assembly from the imaging equipment housing; and
a convergence adjustment assembly mounted within the imaging equipment housing and coupled to each camera barrel assembly to adjust a rotational orientation of each camera barrel assembly about a corresponding pivot axis.

7. The XR headset assembly of claim 1, wherein the convergence adjustment assembly includes:
an adjustment dial positioned between the camera barrel assemblies and accessible through an opening defined along a top surface of the imaging equipment housing; and
a pair of opposing adjustment arms extending outwardly from the adjustment dial and coupled to each camera barrel assembly such that a rotation of the adjustment dial causes each camera barrel assembly to rotate about a corresponding pivot axis in a mirrored relationship.

8. The XR headset assembly of claim 1, wherein the display system includes:
a pair of optical engine assemblies spaced along the transverse axis including a left-eye optical engine assembly positioned adjacent a left eye of the user and a right-eye optical engine assembly positioned adjacent a right eye of the user.

9. The XR headset assembly of claim 8, wherein the display system includes:
an inter-pupil distance (IPD) adjustment system including:
a stationary center support mounted to the headset support frame;
a left transport apparatus slideably mounted to the stationary center support and coupled to the left-eye optical engine assembly for supporting the left-eye optical engine assembly from the stationary center support;
a right transport apparatus slideably mounted to the stationary center support and coupled to the right-eye optical engine assembly for supporting the right-eye optical engine assembly from the stationary center support; and
an actuator configured to selectively move the left transport apparatus and the right transport apparatus along the transverse axis to adjust an inter-pupil spacing between the left-eye optical engine assembly and the right-eye optical engine assembly.

10. The XR headset assembly of claim 8, wherein each optical engine assembly includes a pancake lens assembly pivotable coupled to the headset and including a lens housing containing an image generator and a lens assembly positioned between the image generator and the user's eye along an optical axis.

11. The XR headset assembly of claim 10, wherein the lens assembly includes:
a diopter adjustment lens group movable along the optical axis; and
an opposing pair of stationary singlet lenses positioned between the diopter adjustment lens group and the image generator.

12. The XR headset assembly of claim 11, wherein the diopter adjustment lens group includes a singlet lens and a doublet lens.

13. The XR headset assembly of claim 8, wherein each optical engine assembly includes a near-eye pupil forming catadioptric optical engine.

14. The XR headset assembly of claim 13, wherein the near-eye pupil forming catadioptric optical engine includes:
an image generator forming a 2D image;
a partially transmissive mirror disposed along a first optical axis orientated along an optical path of the user and having a curved reflective surface;
a beam splitter disposed along the first optical axis between an eye of the user and the partially transmissive mirror to reflect light toward the curved mirror surface; and
an optical image relay assembly configured to conjugate the formed 2D image at the image generator to a curved focal surface of the partially transmissive mirror, wherein the curved focal surface is defined between the curved reflective surface of the partially transmissive mirror and the beam splitter, wherein the optical image relay assembly includes:
a prism having an input surface, an output surface, and a folding surface extending between the input and output surfaces and configured for folding an optical path for light generated by the image generator, wherein an aperture stop for the optical image relay lies within the prism;
a first plano-aspheric lens in optical contact against the prism input surface and configured to guide light from the image generator toward the folding surface; and
a second plano-aspheric lens in optical contact against the prism output surface and configured to direct the light towards the beam splitter.

15. The XR headset assembly of claim 13, wherein the near-eye pupil forming catadioptric optical engine includes:
an image generator forming a 2D image;
an optical imaging assembly orientated along a first optical axis and configured to form an exit pupil along the first optical axis orientated along an optical path of the user for viewing the 2D image by the user, the optical imaging assembly including a spherical combiner and a first beam splitter positioned between the spherical combiner and the exit pupil; and
an optical image relay assembly orientated along a second optical axis orientated at an oblique vertical angle from the first optical axis, the optical image relay assembly configured to conjugate the formed 2D image towards the first beam splitter along a third optical axis that is perpendicular to the second optical axis.

16. A method of assembling an extended reality (XR) headset assembly comprising:
providing a headset adapted to be worn by a user and including a support frame including a pair of opposing support arms extending along a longitudinal axis and spaced along a transverse axis perpendicular to the longitudinal axis;
coupling an imaging equipment housing to a forward portion of the support frame and positioned adjacent a forehead of the user;
coupling a display system to the imaging equipment housing, the display system configured to display a display screen including computer-generated images thereon;
mounting a digital optical loupes imaging assembly within the imaging equipment housing positioned above the display system, the digital optical loupes imaging assembly including a pair of 3-dimensional (3D) imaging sensor assemblies spaced along the transverse axis and an illumination assembly positioned between the 3D imaging sensor assemblies; and
coupling a controller to the digital optical loupes imaging assembly and the display system, the controller including one or more processors programmed to display computer-generated images on the display system using image data received from the digital optical loupes imaging assembly.

17. The method of claim 16, wherein each 3D imaging sensor assembly includes:
a camera barrel assembly including:
a camera housing extending along a centerline axis between a first end and an opposite second end;
an image sensor mounted within the camera housing adjacent the first end;
a mirror mounted within the camera housing adjacent the opposite second end at an oblique angle with respect to the image sensor and spaced a distance from the image sensor along the centerline axis; and
a camera lens assembly mounted within the camera housing and positioned between the image sensor and the mirror along the centerline axis to direct light rays from the mirror towards the image sensor.

18. The method of claim 16, wherein each optical engine assembly includes a pancake lens assembly pivotable coupled to the headset and including a lens housing containing an image generator and a lens assembly positioned between the image generator and the user's eye along an optical axis;
wherein the lens assembly includes:
a diopter adjustment lens group movable along the optical axis; and
an opposing pair of stationary singlet lenses positioned between the diopter adjustment lens group and the image generator.

19. The method of claim 16, wherein each optical engine assembly includes a near-eye pupil forming catadioptric optical engine including:
an image generator forming a 2D image;
a partially transmissive mirror disposed along a first optical axis orientated along an optical path of the user and having a curved reflective surface;
a beam splitter disposed along the first optical axis between an eye of the user and the partially transmissive mirror to reflect light toward the curved mirror surface; and
an optical image relay assembly configured to conjugate the formed 2D image at the image generator to a curved focal surface of the partially transmissive mirror, wherein the curved focal surface is defined between the curved reflective surface of the partially transmissive mirror and the beam splitter, wherein the optical image relay assembly includes:
a prism having an input surface, an output surface, and a folding surface extending between the input and output surfaces and configured for folding an optical path for light generated by the image generator, wherein an aperture stop for the optical image relay lies within the prism;
a first plano-aspheric lens in optical contact against the prism input surface and configured to guide light from the image generator toward the folding surface; and
a second plano-aspheric lens in optical contact against the prism output surface and configured to direct the light towards the beam splitter.

20. The method of claim 16, wherein each optical engine assembly includes a near-eye pupil forming catadioptric optical engine including:
an image generator forming a 2D image;
an optical imaging assembly orientated along a first optical axis and configured to form an exit pupil along the first optical axis orientated along an optical path of the user for viewing the 2D image by the user, the optical imaging assembly including a spherical combiner and a first beam splitter positioned between the spherical combiner and the exit pupil; and
an optical image relay assembly orientated along a second optical axis orientated at an oblique vertical angle from the first optical axis, the optical image relay assembly configured to conjugate the formed 2D image towards the first beam splitter along a third optical axis that is perpendicular to the second optical axis.
